(19) United States
(12) Patent Application Publication
(10) Pub. No.: US 2026/0339159 A1
(43) Pub. Date: Oct. 29, 2026

(54) MACH-ZEHNDER ELECTRO-OPTIC MODULATOR AND METHOD FOR MANUFACTURING SAME

(71) Applicant: SHANGHAI INSTITUTE OF MICROSYSTEM AND INFORMATION TECHNOLOGY, CHINESE ACADEMY OF SCIENCES, Shanghai (CN)

(72) Inventors: Zhuoyun LI, Shanghai (CN); Yan CAI, Shanghai (CN); Shuxiao WANG, Shanghai (CN)

(73) Assignee: SHANGHAI INSTITUTE OF MICROSYSTEM AND INFORMATION TECHNOLOGY, CHINESE ACADEMY OF SCIENCES, Shanghai (CN)

(21) Appl. No.: 19/117,961

(22) PCT Filed: Nov. 7, 2023
(86) PCT No.: PCT/CN2023/130268

§ 371 Date: Apr. 2, 2025

(30) Foreign Application Priority Data
Sep. 5, 2023 (CN) 202311137704.9

(51) Int. Cl. G02F 1/21; G02F 1/035; G02F 1/225

(52) U.S. Cl. CPC G02F 1/212; G02F 1/035; G02F 1/2257; G02F 2202/20

(57) ABSTRACT

A Mach-Zehnder electro-optic modulator and method for manufacturing the same is provided. The modulator includes, from the bottom up, a substrate layer, a silicon waveguide layer, a first isolation layer, a silicon nitride waveguide layer, a second isolation layer, a lithium niobate thin film layer, a third isolation layer and a metal layer. The silicon waveguide layer includes a splitter and a combiner located on opposite sides of the silicon waveguide layer, and the silicon waveguide layer further includes more than two modulation arms connected to the splitter and combiner, and extending towards corresponding coupling regions, wherein a hybrid waveguide serves as an active modulation arm. The hybrid waveguide includes a silicon nitride strip waveguide in the silicon nitride waveguide layer and the lithium niobate thin film layer, and a thickness of the second isolation layer is less than 50 nm.

### FIELD OF TECHNOLOGY

The present disclosure relates to semiconductor device technology, specifically to silicon photonic devices, and more particularly to a Mach-Zehnder electro-optic modulator and method for manufacturing the same.

### BACKGROUND

Silicon photonics technology (SiPh) uses photons as the information transmission medium, offering advantages such as high speed, high bandwidth, low latency, and low power consumption. By integrating modulators, detectors, and various functional passive devices, SiPh enables on-chip optical interconnections, which can be widely used in high-performance computing and optical communications. Additionally, due to its compatibility with complementary metal-oxide-semiconductor (CMOS) manufacturing processes, SiPh is expected to enable the mass production of high-density chips through cost-effective manufacturing techniques. Electro-optic modulators, which convert electrical signals into optical signals, are one of the core components of silicon photonics technology.

A multilayer SiN-on-SOI platform, with one or more SiN waveguide layers deposited on a Si photonic layer, leverages both the complete set of optical functional devices on the SOI platform and the ultra-low transmission loss of silicon nitride waveguides. At the same time, SOI or SiN photonic wafers serve as a platform for integrating various other optical materials, mixing various functional materials with silicon while maintaining CMOS compatibility, to enhance the functionalities of the silicon photonics platform.

Lithium niobate material, with its wide transparent window and large electro-optic coefficient, is widely used in high-speed modulation. Existing lithium niobate hybrid integrated modulators are broadly categorized into two types: silicon nitride-lithium niobate hybrid integration and silicon-lithium niobate hybrid integration. However, these two types of modulators have their respective issues. For example, the silicon-lithium niobate hybrid integration platform has higher transmission loss, while the silicon nitride-lithium niobate heterogeneous integration platform, although having lower transmission loss, lacks the ability to integrate active devices like germanium-silicon detectors.

It should be noted that the above introduction to the technical background is only to facilitate a clear and complete explanation of the technical solutions of the present disclosure and to aid the understanding of technical personnel in this field. It cannot be assumed that the above-mentioned technical solutions are known to those skilled in the art merely because they are set forth in the background section of the present disclosure.

### SUMMARY

In view of the disadvantages of the related technology, the present disclosure provides a Mach-Zehnder electro-optic modulator and method for manufacturing the same to solve the various problems of existing lithium niobate hybrid integrated modulators, such as the higher transmission loss in the silicon-lithium niobate hybrid integration platform, and the lack of integration capability with active devices such as germanium-silicon detectors in the silicon nitride-lithium niobate heterogeneous integration platform, despite its lower transmission loss compared to the silicon-lithium niobate heterogeneous platform.

To achieve the above and related objectives, the present disclosure provides a Mach-Zehnder electro-optic modulator. The Mach-Zehnder electro-optic modulator includes, from the bottom up, a substrate layer, a silicon waveguide layer, a first isolation layer, a silicon nitride waveguide layer, a second isolation layer, a lithium niobate thin film layer, a third isolation layer, and a metal layer; wherein a surface of the substrate layer is an insulating material layer; wherein the silicon waveguide layer includes a splitter and a combiner located on opposite sides of the silicon waveguide layer, and the silicon waveguide layer further includes more than two modulation arms connected to the splitter and combiner, and extending towards corresponding coupling regions, wherein a hybrid waveguide serves as an active modulation arm, wherein the hybrid waveguide includes a silicon nitride strip waveguide in the silicon nitride waveguide layer and the lithium niobate thin film layer, and a thickness of the second isolation layer between the silicon nitride waveguide layer and the lithium niobate thin film layer is less than 50 nm.

Optionally, the Mach-Zehnder electro-optic modulator further includes an upper cladding layer covering the metal layer.

Optionally, refractive indices of the first isolation layer, the second isolation layer, the third isolation layer, and the upper cladding layer are lower than those of their respective adjacent waveguide layers.

Optionally, the substrate layer includes a silicon wafer and a silicon dioxide layer over the silicon wafer, wherein the first isolation layer, the second isolation layer, the third isolation layer, and the upper cladding layer all include silicon dioxide layers.

Optionally, a thickness of the silicon waveguide layer is 200 nm-250 nm, a thickness of the first isolation layer is 120 nm-150 nm, a thickness of the silicon nitride waveguide layer is 350 nm-450 nm, a thickness of the second isolation layer is 10 nm-45 nm, a thickness of the lithium niobate thin film layer is 350 nm-450 nm, a thickness of the third isolation layer is 150 nm-250 nm, a thickness of the metal layer is 0.5 μm-1.5 μm, and a thickness of the upper cladding layer is 1.5 μm-2.5 μm.

Optionally, the thickness of the silicon waveguide layer is 220 nm, the thickness of the first isolation layer is 140 nm, the thickness of the silicon nitride waveguide layer is 400 nm, the thickness of the second isolation layer is 30 nm, the thickness of the lithium niobate thin film layer is 400 nm, the thickness of the third isolation layer is 200 nm, the thickness of the metal layer is 1 μm, and the thickness of the upper cladding layer is 2 μm.

Optionally, a material of the metal layer includes several of aluminum, silver, copper, gold, and platinum.

Optionally, a recess is formed in a region of the substrate layer corresponding to the silicon waveguide.

The present disclosure also provides a method for manufacturing a Mach-Zehnder electro-optic modulator, including: preparing a silicon waveguide layer on a substrate layer, and then sequentially preparing a first isolation layer, a silicon nitride waveguide layer, a second isolation layer, a lithium niobate thin film layer, a third isolation layer, and a metal layer, wherein the lithium niobate thin film layer and the silicon waveguide layer are prepared on separate substrates, and then the lithium niobate thin film layer is bonded over the silicon nitride waveguide layer.

Optionally, the method for manufacturing the silicon waveguide layer on the substrate layer includes providing an SOI wafer and performing photolithography and etching on the top silicon layer of the SOI wafer to obtain a patterned silicon waveguide layer and unit devices.

Optionally, the first isolation layer, the silicon nitride waveguide layer, and the second isolation layer are sequentially prepared to obtain a first bonded wafer after the silicon waveguide layer is prepared on the substrate layer, and then the first bonded wafer is directly bonded with a second bonded wafer formed with the lithium niobate thin film layer, wherein the lithium niobate thin film layer and the second isolation layer are bonded with each other, then a substrate of the second bonded wafer is thinned, and then a metal layer and an upper cladding layer are prepared on a side of the lithium niobate thin film layer facing away from the silicon nitride waveguide layer.

As described above, the Mach-Zehnder electro-optic modulator and method for manufacturing the same provided by the present disclosure have the following beneficial effects: the embodiments creatively prepare the Mach-Zehnder electro-optic modulator with a silicon-silicon nitride-lithium niobate three-layer waveguide and optimize the positions and thicknesses of each structural layer. Therefore, the present disclosure can fully utilize the excellent electro-optic modulation performance of lithium niobate and the low optical properties of silicon nitride, which has lower transmission loss compared to silicon, effectively reducing transmission loss and avoiding the etching process of the lithium niobate material. Meanwhile, the non-modulation arm region uses silicon material, leveraging silicon's active capabilities and its potential for monolithic integration with other active devices, such as germanium-silicon detectors, so it is possible to achieve on-chip integration of the modulator and detector, which streamlines the preparation process, reduces manufacturing costs, and facilitates large-scale application.

### BRIEF DESCRIPTION OF THE DRAWINGS

FIG. 1 shows a schematic diagram of an exemplary planar structure of a Mach-Zehnder electro-optic modulator of the present disclosure.

FIG. 2 shows a cross-sectional schematic diagram of FIG. 1 along a direction perpendicular to a transmission direction of optical waveguides in a single modulation arm.

FIG. 3 shows a schematic diagram of optical mode field distribution in a SiN-LN (lithium niobate) hybrid waveguide.

FIG. 4 shows a schematic diagram of electrostatic field distribution in a single modulation arm.

FIG. 5 illustrates the dependence of characteristic impedance on signal electrode width and thickness for various transmission lines.

FIG. 6 illustrates the dependence of attenuation coefficient on signal electrode width and thickness for various transmission lines.

FIG. 7 illustrates the dependence of effective microwave refractive index on signal electrode width and thickness for various transmission lines.

FIG. 8 shows electro-optic response curves of the electro-optic modulator corresponding to different modulation region lengths, that is, a schematic diagram of relationship between optical power and electrical signal frequency.

FIG. 9 shows an optical mode transmission diagram of an optimized silicon-SiN/LN interlayer coupler, where the horizontal coordinates correspond to positions on x-axis of this structure, and the vertical coordinates correspond to positions on z-axis.

FIG. 10 shows a transmission spectrum of an optimized silicon-SiN/LN interlayer coupler, where the horizontal coordinates are optical wavelength, and the vertical coordinates are optical power intensity received by a monitor (total amount is 1).

FIG. 11 shows a schematic diagram of a preparation process of a Mach-Zehnder electro-optic modulator of the present disclosure.

### DETAILED DESCRIPTION

The embodiments of the present disclosure will be described below. Those skilled can easily understand advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. When describing the embodiments of the present disclosure, for better explanation, cross-sectional structural diagrams may be partially enlarged without following the general scale. Moreover, the diagrams are only examples and should not limit the scope of the present disclosure. In addition, the actual production should comprise the length, width and depth of the three-dimensional space dimensions.

For the convenience of description, spatial relation terms such as “below”, “under”, “beneath”, “on”, “above”, “up”, etc. may be used herein to describe the relationships between an element or feature and other elements or features. It will be understood that these spatial relationship terms are intended to encompass directions/orientations of the device in use or operation other than those depicted in the drawings. In addition, when a first layer is referred to as being “between” a second layer and a third layer, the first layer may be the only layer between the second and third layers, or there may more layers between the two layers.

In the context of this disclosure, the structure described with a first feature “on top” of a second feature may comprise embodiments where the first and second features are formed in direct contact, or it may comprise embodiments where additional features are formed between the first and second features such that the first and second features are not in direct contact.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components'layout may also be more complicated. To keep the illustrations as simple as possible, not all structures are labeled in each figure.

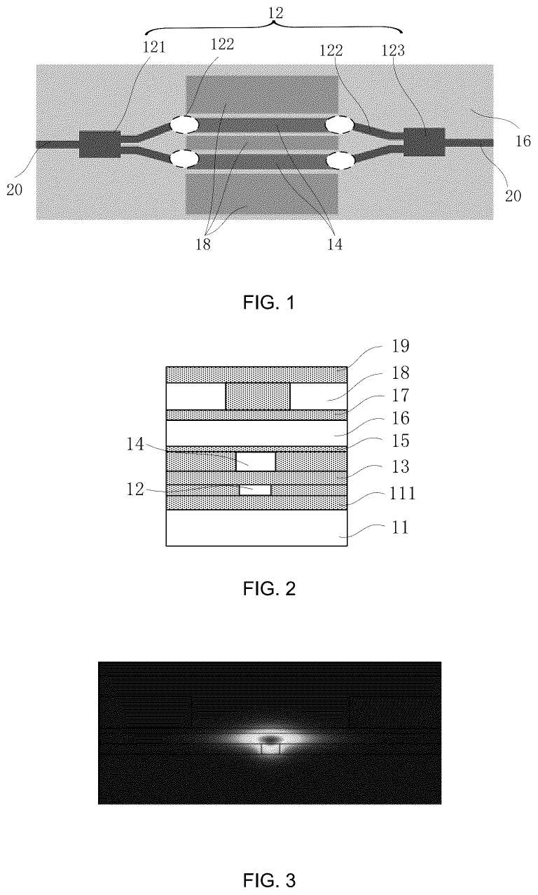

As shown in FIG. 1 and FIG. 2, a Mach-Zehnder electro-optic modulator is provided, the Mach-Zehnder electro-optic modulator including: from the bottom up, a substrate layer 11, a silicon waveguide layer 12, a first isolation layer 13, a silicon nitride waveguide layer 14, a second isolation layer 15, a lithium niobate thin film layer 16, a third isolation layer 17, and a metal layer 18;
a surface of the substrate layer 111 is an insulating material layer; For example, the substrate layer 11 is a single structural layer, that is, the substrate layer is made of a single insulating material. For instance, the substrate layer 11 is made of quartz glass or other organic materials such as benzocyclobutene (BCB) with a refractive index lower than that of the waveguide layer. In other examples, the substrate layer 11 is a composite structural layer, composed of multiple material layers stacked vertically. For instance, the substrate layer 11 includes a silicon wafer layer at the bottom and a silicon dioxide layer on a surface of the silicon wafer layer. The silicon dioxide layer can be formed on the surface of the silicon wafer layer through thermal oxidation and/or chemical vapor deposition processes. In the present disclosure, the preferred material for the substrate layer 11 is a silicon-based material, such as the aforementioned composite structural layer composed of a silicon wafer layer and a silicon dioxide layer. This allows the Mach-Zehnder electro-optic modulator provided by the present disclosure to be more compatible with CMOS processes. In further examples, a groove is formed in a region of the substrate layer 11 corresponding to the silicon waveguide, so that the silicon waveguide is in a suspended state. This helps to reduce or even prevent heat from spreading outward from the substrate layer 11, which helps to reduce thermal modulation loss and further improve the electro-optic modulation efficiency of the modulator. In other examples, a thermal insulation layer is set on a surface of the substrate layer 11 or a surface of the groove.

The silicon waveguide layer 12 forms a silicon waveguide structure, such as a beam splitter 121 and a combiner 123 located on opposite sides (the combiner 123 and the beam splitter 121 are located on opposite sides of a phase modulation region, i.e., coupling region), and more than two modulation arms 122 connected to the beam splitter 121 and combiner 123, respectively, and extending in opposite directions to a corresponding coupling region. FIG. 1 takes two silicon modulation arms 122 as an example.

A hybrid waveguide serves as an active modulation arm, wherein the hybrid waveguide includes a silicon nitride strip waveguide in the silicon nitride waveguide layer 14 and a lithium-niobate (LN) waveguide layer. Each isolation layer is used to separate adjacent waveguide layers, wherein a thickness of the second isolation layer 15 between the silicon nitride waveguide layer 14 and the lithium niobate thin film layer 16 is less than 50 nm. Due to structural improvements, the modulator of the present disclosure does not have RF loss problems, allowing the second isolation layer 15 to be very thin, or even completely removed, to achieve higher modulation efficiency.

The silicon waveguide layer 12 is a passive region of the electro-optic modulator, responsible for optical routing, splitting, and combining. It should be noted that, although the beam splitter 121 is shown on a left side and the combiner 123 on a right side in the modulation region in FIG. 1, the silicon waveguide structure in the silicon waveguide layer 12 is symmetrically distributed, so the left side can also be considered as the combiner 123 and the right side as the beam splitter 121, depending on the direction of optical transmission. The silicon waveguide layer 12 has coupling regions (as marked by dashed lines in FIG. 1). The light transmitted in the silicon waveguide layer 12 can be coupled into the SiN-LN hybrid waveguide through coupling regions on a left side of FIG. 1. The modulated light in the hybrid waveguide can be coupled back into the silicon waveguide layer 12 through coupling regions on a right side of FIG. 1. To improve coupling efficiency, the coupling regions of the silicon waveguide layer 12 are tapered structures. That is, in the coupling regions, a width of the silicon waveguide layer 12 varies linearly along a transmission direction of the light. For example, a width of the coupling regions on the left side of FIG. 1 gradually decreases along the transmission direction of the light, while a width of the coupling regions on the right side of FIG. 1 gradually increases along the transmission direction of the light.

Lithium niobate has the characteristic that its refractive index varies proportionally with the intensity of the applied electric field. Therefore, when an electric field is applied to the lithium niobate thin film layer 16, a refractive index of the lithium niobate thin film layer 16 changes, thereby altering propagation characteristics of the light to achieve phase modulation. The ridge-type hybrid waveguide, composed of the silicon nitride waveguide layer 14 and the lithium niobate thin film layer 16 with different refractive indices (a rib of the ridge is the silicon nitride waveguide, and a slab of the ridge is the lithium niobate material), enhances waveguide structure's ability to confine light field, reduces optical loss, and improves modulation efficiency. Certainly, in other examples, the lithium niobate thin film layer 16 can be replaced with other electro-optic material layers with linear electro-optic effects, such as lithium tantalate, lithium tantalate niobate, barium titanate, lead zirconate titanate (PZT), or some electro-optic polymers. However, relatively speaking, lithium niobate has more excellent electro-optic, acousto-optic, and optical nonlinear effects, and its preparation process is also relatively more mature.

The metal layer 18 serves as a metal electrode, and a main function of the metal layer is to transmit microwave signals to electrodes through external metal probes when the device is in operation.

The exemplary working principle of the Mach-Zehnder electro-optic modulator of the present disclosure is as follows: The light emitted from devices such as lasers enters the grating coupler (i.e., the beam splitter 121) of the silicon waveguide layer 12 from the input optical fiber 20 (for example, the one on the left), and then split by the 1*2 MMI (multi-mode interference coupler) of the silicon waveguide layer 12, and then coupled into the hybrid waveguide composed of the silicon nitride/lithium niobate waveguide through the tapered optical coupling region of the silicon waveguide layer 12, entering the active modulation arm region for transmission. The modulated light is then coupled back to the silicon waveguide layer 12 through an interlayer coupler (i.e., the combiner 123), recombined by the 1*2 MMI of the silicon waveguide layer, and finally coupled to the output optical fiber 20 (for example, the one on the right) through the silicon grating, transmitted through the output optical fiber 20 to devices such as germanium-silicon detector.

The present disclosure creatively prepares a Mach-Zehnder electro-optic modulator with a silicon-silicon nitride-lithium niobate three-layer waveguide and carefully designs the positions and thicknesses of each structural layer. This allows for the full utilization of the excellent electro-optic modulation performance of the lithium niobate material and the lower optical transmission loss of the silicon nitride material compared to silicon, effectively reducing transmission loss and avoiding the etching process of the lithium niobate material. Meanwhile, the non-modulation arm region uses silicon material, leveraging silicon's active capabilities and its potential for monolithic integration with other active devices, such as germanium-silicon detectors, so it is possible to achieve on-chip integration of the modulator and detector, helping to simplify the preparation process, reduce manufacturing costs, and facilitate large-scale application.

In some examples, the Mach-Zehnder electro-optic modulator further includes an upper cladding layer 19 covering the metal layer 18. The upper cladding layer 19 is typically an insulating material layer 111, which not only prevents oxidation contamination of the metal layer 18 but also reduces the distribution range of the evanescent field, thereby further improving the modulator's performance. The upper cladding layer 19 can be any inorganic material such as a silicon dioxide layer, a silicon oxynitride layer, or a silicon nitride layer. In other examples, the upper cladding layer 19 can be organic material layer such as a polyimide layer.

To ensure the performance of the modulator, the refractive indices of the first isolation layer 13, the second isolation layer 15, the third isolation layer 17, and the upper cladding layer 19 are preferably all lower than those of the adjacent waveguide layers. The materials of the first isolation layer 13, the second isolation layer 15, the third isolation layer 17, and the upper cladding layer 19 can be the same or different. In the present disclosure, since the material of a first waveguide layer is silicon, the material of a second waveguide layer is silicon nitride, and the material of a third waveguide layer is lithium niobate, from the perspective of simplifying the preparation process and improving the interface performance of different material layers, the first isolation layer 13, the second isolation layer 15, the third isolation layer 17, and the upper cladding layer 19 are preferably silicon dioxide layers, or alternatively silicon oxynitride layers. When using silicon oxynitride layers, the refractive index can be adjusted by changing the oxygen content in the silicon oxynitride layer and/or the oxygen, to better match the adjacent waveguide layers. In some examples, when the relevant isolation layers use silicon oxynitride layers, the isolation layers can have a gradient refractive index.

The metal layer 18 needs to be made of materials with good electrical conductivity, such as aluminum, silver, copper, gold, or platinum. The metal layer 18 can be a single metal material or an alloy. To be more compatible with the CMOS manufacturing process, the preferred materials for the metal layer 18 are aluminum or copper.

A thickness of each material layer has a significant impact on the electro-optic tuning performance and transmission loss of the electro-optic modulator. Therefore, the thickness of each material layer needs to be carefully designed, as it cannot be too thick or too thin. Through extensive experiments, it was found that a preferred thickness of each material layer is as follows: a thickness of the silicon waveguide layer 12 is 200 nm-250 nm (each value range in the present disclosure, unless otherwise specified, includes the endpoints), a thickness of the first isolation layer 13 is 120 nm-150 nm, a thickness of the silicon nitride waveguide layer 14 is 350 nm-450 nm, a thickness of the second isolation layer 15 is 10 nm-45 nm, a thickness of the lithium niobate thin film layer 16 is 350 nm-450 nm, a thickness of the third isolation layer 17 is 150 nm-250 nm, a thickness of the metal layer 18 is 0.5 μm-1.5 μm, and a thickness of the upper cladding layer 19 is 1.5 μm-2.5 μm. It should be noted that the thickness of each material layer may not be the same at all places, so the above values refer to the maximum thickness of the corresponding material layer. In a specific example, the thickness of the silicon waveguide layer 12 is 220 nm, the thickness of the first isolation layer 13 is 140 nm, the thickness of the silicon nitride waveguide layer 14 is 400 nm, the thickness of the second isolation layer 15 is 30 nm, the thickness of the lithium niobate thin film layer 16 is 400 nm, the thickness of the third isolation layer 17 is 200 nm, the thickness of the metal layer 18 is 1 μm, and the thickness of the upper cladding layer 19 is 2 μm.

In some examples, the Mach-Zehnder electro-optic modulator may also be equipped with reflectors (not shown). The reflectors can be arranged along a light transmission path, for instance, on sides of one of the waveguide layers (non-optical coupling surface). For example, in one instance, reflectors are placed on sides of the silicon waveguide layer. More specifically, the reflectors are set on two opposite sides of the coupling region of the silicon waveguide layer. The reflectors can be Bragg reflectors or metal reflectors. The inclusion of reflectors helps to further improve the performance of the devices.

In some examples, the silicon waveguide layer 12 has an array structure, which includes multiple silicon waveguides arranged in an array with intervals. In this case, isolation material layers can be set between adjacent silicon waveguide structures to prevent optical crosstalk. For example, in one embodiment, an isolation material can be set between the two silicon modulation arms 122. The isolation material layer, for instance, can be an insulating material layer with photochromic properties, thereby preventing crosstalk from light leaking out of different optical waveguides.

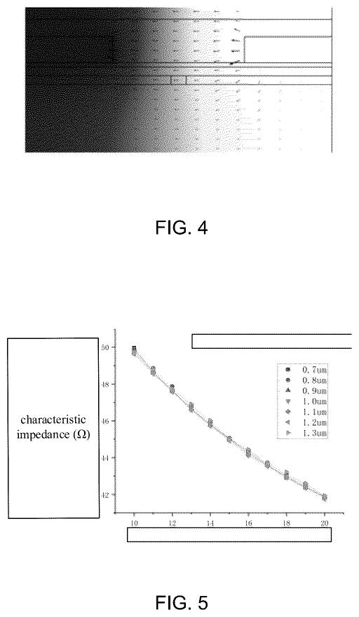

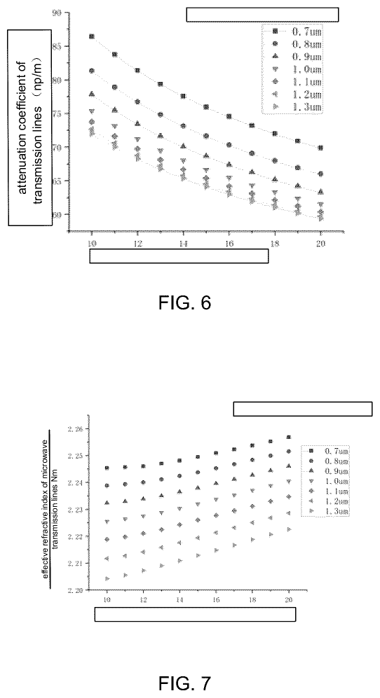

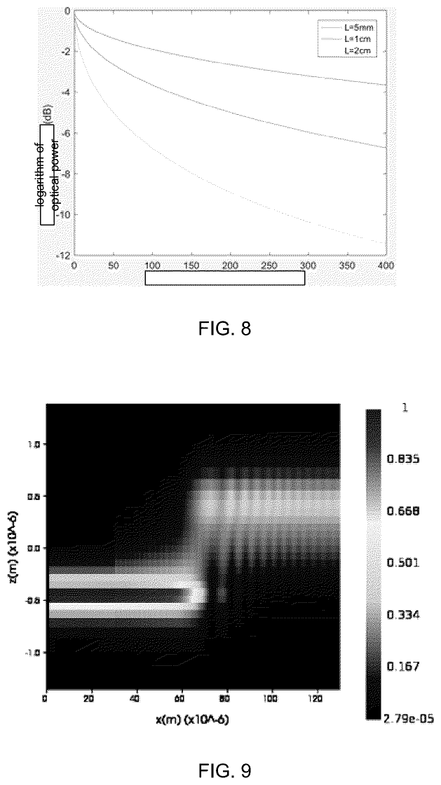

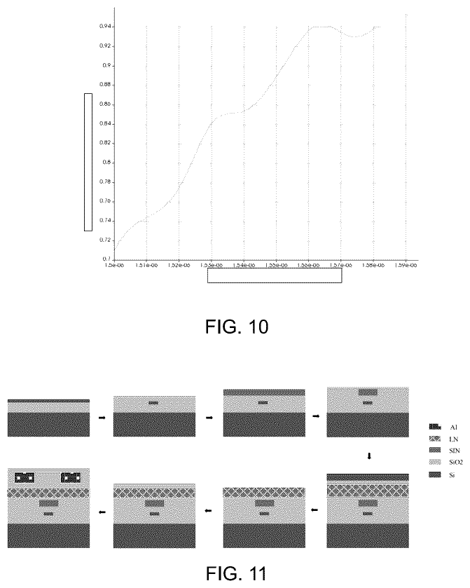

To verify the performance of the Mach-Zehnder electro-optic modulator in the present disclosure, the inventors conducted extensive experiments. After simulation optimization, in the TE (Transverse Electric) mode at a wavelength of 1550 nm, the Mach-Zehnder electro-optic modulator based on the silicon-silicon nitride-lithium niobate hybrid integrated platform achieves an electro-optic bandwidth exceeding 130 GHz and a half-wave voltage-length product of 2.58 Vcm. The optical mode field and electrostatic field distributions in the single-ended modulation arm 123 are shown in FIG. 3 and FIG. 4, respectively; the port characteristics of the coplanar electrode transmission line, including the characteristic impedance, attenuation coefficient, and effective microwave refractive index variation with the signal electrode width and thickness, are shown in FIG. 5 to FIG. 7; the electro-optic response curves of the electro-optic modulators with different modulation region lengths after size optimization are shown in FIG. 8; the simulation also optimized an interlayer coupler structure with an insertion loss of 1 dB, whose optical mode transmission diagram is shown in FIG. 9, and the transmission spectrum at 1500~1600 nm is shown in FIG. 10. These simulation results indicate that the performance of the electro-optic modulator of the present disclosure is not inferior to the existing silicon-lithium niobate hybrid integrated platform and silicon-lithium niobate heterogeneous platform. It also has the advantages of low transmission loss of the silicon nitride-lithium niobate heterogeneous integrated platform and the integration capability with active devices such as germanium-silicon detectors of the silicon-lithium niobate hybrid integrated platform.

The present disclosure also provides a method for manufacturing the Mach-Zehnder electro-optic modulator, which can be used to prepare the Mach-Zehnder electro-optic modulator described in any of the above embodiments. Therefore, the previous description of the Mach-Zehnder electro-optic modulator is also applicable here, and will not be repeated for the sake of brevity. The method for manufacturing a Mach-Zehnder electro-optic modulator of the present disclosure, including: preparing a silicon waveguide layer 12 on a substrate layer, and then sequentially preparing a first isolation layer 13, a silicon nitride waveguide layer 14, a second isolation layer 15, a lithium niobate thin film layer 16, a third isolation layer 17, a metal layer 18, and a upper cladding layer 19, wherein the lithium niobate thin film layer 16 and the silicon waveguide layer 12 are prepared on separate substrates, and then the lithium niobate thin film layer is bonded over the silicon nitride waveguide layer 14. In other words, in the method provided by this embodiment, the preparation of the lithium niobate thin film layer 16 is independent of the preparation of the silicon waveguide layer 12 and the silicon nitride waveguide layer 14. This can avoid the etching process of the lithium niobate thin film layer 16, reducing or even preventing damage to the lithium niobate thin film layer 16 during the manufacturing process, thereby ensuring its modulation performance.

In a preferred example, the method for manufacturing the silicon waveguide layer on the substrate layer 11 includes providing an SOI wafer and performing photolithography and etching on the top silicon layer of the SOI wafer to obtain the silicon waveguide layer 12 with a patterned silicon waveguide layer and unit devices. Certainly, in other examples, the process of forming the silicon waveguide layer 12 on the substrate layer 11 can also start with providing a base layer. If the base layer is a semiconductor material wafer such as silicon, germanium, silicon-germanium, or gallium arsenide, an insulating structural layer such as an oxide layer is first formed on the base layer, and then a polysilicon layer is formed on the insulating structural layer using processes including but not limited to chemical vapor deposition. The polysilicon layer is then photolithographically etched to obtain the silicon waveguide layer 12. If the base layer is an insulating material such as quartz glass, a polysilicon layer can be directly formed on the base layer and then photolithographically etched. However, using an SOI wafer and photolithographically etching the top silicon layer of the SOI wafer to obtain the silicon waveguide layer 12 helps simplify the preparation process.

Next, the method of the present disclosure will be explained in more detail with reference to FIG. 11. It should be noted that in the present disclosure, all isolation layers are silicon dioxide layers and the metal layer 18 is an aluminum layer, but in practical applications, the materials of the isolation layers and the metal layer 18 are not limited to these.

As shown in FIG. 11, the process for manufacturing the Mach-Zehnder electro-optic modulator of the present disclosure includes:
firstly, preparing the first bonding wafer and the second bonding wafer; the preparation process of the first bonding wafer includes: providing an SOI wafer, performing photolithographic etching on the top silicon layer of the SOI wafer to obtain the silicon waveguide layer 12, the bottom silicon layer of the SOI wafer forming the substrate layer 11, and the insulating layer of the SOI wafer forming the insulating material layer 111 on the substrate layer 11;
next, forming a silicon dioxide layer covering the silicon waveguide layer 12 using a process including but not limited to chemical vapor deposition, to serve as the first isolation layer 13;
then, forming a silicon nitride material layer on the first isolation layer 13 using a process including but not limited to chemical vapor deposition, and performing photolithographic etching on the silicon nitride material layer to obtain the silicon nitride waveguide layer 14;
next, forming a silicon dioxide layer covering the silicon nitride waveguide layer 14 using a process including but not limited to chemical vapor deposition, to serve as the second isolation layer 15, thereby obtaining the first bonding wafer;
the preparation process of the second bonding wafer includes: providing a substrate, which can be a silicon wafer with a silicon dioxide layer on the surface, but is not limited to this, and can also be a glass substrate or an organic material substrate;
forming the lithium niobate thin film layer 16 on the substrate layer using a method including but not limited to the sol-gel method to obtain the second bonding wafer, then, directly bonding the first wafer with the second bonding wafer, with the lithium niobate thin film layer 16 bonding to the second isolation layer 15;
next, thinning the substrate of the second bonding wafer, for example, by grinding off the silicon substrate of the second bonding wafer and thinning the lithium niobate material layer to a preset thickness, then, forming the third isolation layer 17 on the lithium niobate thin film layer 16;
after that, forming the metal layer 18 and the upper cladding layer 19 on the side of the lithium niobate thin film layer 16 that faces away from the silicon nitride waveguide layer 14, for example, on the third isolation layer 17.

In summary, the present disclosure creatively prepares a Mach-Zehnder electro-optic modulator with a silicon-silicon nitride-lithium niobate three-layer waveguide and carefully designs the positions and thicknesses of each structural layer. This allows for the full utilization of the excellent electro-optic modulation performance of the lithium niobate material and the lower optical transmission loss of the silicon nitride material compared to silicon, effectively reducing transmission loss and avoiding the etching process of the lithium niobate material. Meanwhile, the non-modulation arm region uses silicon material. By leveraging silicon's active capabilities and its potential for monolithic integration with other active devices, such as germanium-silicon detectors, it is possible to achieve on-chip integration of the modulator and detector. This helps simplify the preparation process, reduce manufacturing costs, and facilitate large-scale application. Therefore, the present disclosure effectively overcomes various shortcomings in the existing technology and has high industrial utilization value.

The above-mentioned embodiments are merely illustrative of the principle and effects of the present disclosure instead of restricting the scope of the present disclosure. Any person skilled in the art may modify or change the above embodiments without violating the principle of the present disclosure. Therefore, all equivalent modifications or changes made by those who have common knowledge in the art without departing from the spirit and technical concept disclosed by the present disclosure shall be still covered by the claims of the present disclosure.

What is claimed is:

1. A Mach-Zehnder electro-optic modulator, comprising: from the bottom up, a substrate layer, a silicon waveguide layer, a first isolation layer, a silicon nitride waveguide layer, a second isolation layer, a lithium niobate thin film layer, a third isolation layer, and a metal layer; wherein a surface of the substrate layer is an insulating material layer; wherein the silicon waveguide layer comprises a splitter and a combiner located on opposite sides of the silicon waveguide layer, and the silicon waveguide layer further comprises more than two modulation arms connected to the splitter and combiner, and extending towards corresponding coupling regions, wherein a hybrid waveguide serves as an active modulation arm, wherein the hybrid waveguide comprises a silicon nitride strip waveguide in the silicon nitride waveguide layer and the lithium niobate thin film layer, and a thickness of the second isolation layer between the silicon nitride waveguide layer and the lithium niobate thin film layer is less than 50 nm.

2. The Mach-Zehnder electro-optic modulator according to claim 1, wherein the Mach-Zehnder electro-optic modulator further comprises an upper cladding layer covering the metal layer, wherein refractive indices of the first isolation layer, the second isolation layer, the third isolation layer, and the upper cladding layer are lower than those of respective adjacent waveguide layers.

3. The Mach-Zehnder electro-optic modulator according to claim 2, wherein the substrate layer comprises a silicon wafer and silicon dioxide layers over the silicon wafer, wherein the first isolation layer, the second isolation layer, the third isolation layer, and the upper cladding layer all comprise silicon dioxide layers.

4. The Mach-Zehnder electro-optic modulator according to claim 2, wherein a thickness of the silicon waveguide layer is 200 nm-250 nm, a thickness of the first isolation layer is 120 nm-150 nm, a thickness of the silicon nitride waveguide layer is 350 nm-450 nm, a thickness of the second isolation layer is 10nm-45 nm, a thickness of the lithium niobate thin film layer is 350 nm-450 nm, a thickness of the third isolation layer is 150 nm-250 nm, a thickness of the metal layer is 0.5 μm-1.5 μm, and a thickness of the upper cladding layer is 1.5μm-2.5 μm.

5. The Mach-Zehnder electro-optic modulator according to claim 4, wherein the thickness of the silicon waveguide layer is 220 nm, the thickness of the first isolation layer is 140 nm, the thickness of the silicon nitride waveguide layer is 400 nm, the thickness of the second isolation layer is 30 nm, the thickness of the lithium niobate thin film layer is 400 nm, the thickness of the third isolation layer is 200 nm, the thickness of the metal layer is 1 μm, and the thickness of the upper cladding layer is 2 μm.

6. The Mach-Zehnder electro-optic modulator according to claim 1, wherein a material of the metal layer comprises several of aluminum, silver, copper, gold, and platinum.

7. The Mach-Zehnder electro-optical modulator according to claim 1, wherein a recess is formed in a region of the substrate layer corresponding to a silicon waveguide.

8. A method for manufacturing a Mach-Zehnder electro-optic modulator, comprising: preparing a silicon waveguide layer on a substrate layer, and then sequentially preparing a first isolation layer, a silicon nitride waveguide layer, a second isolation layer, a lithium niobate thin film layer, a third isolation layer, and a metal layer, wherein the lithium niobate thin film layer and the silicon waveguide layer are prepared on separate substrates, and then the lithium niobate thin film layer is bonded over the silicon nitride waveguide layer.

9. The method for manufacturing a Mach-Zehnder electro-optic modulator according to claim 8, wherein the method for manufacturing the silicon waveguide layer on the substrate layer comprises providing an SOI wafer, performing photolithography and etching on a top silicon layer of the SOI wafer to obtain a silicon waveguide layer with patterned silicon waveguides and unit devices.

10. The method for manufacturing a Mach-Zehnder electro-optic modulator according to claim 8, wherein the first isolation layer, the silicon nitride waveguide layer, and the second isolation layer are sequentially prepared to obtain a first bonded wafer after the silicon waveguide layer is prepared on the substrate layer, and then the first bonded wafer is directly bonded with a second bonded wafer formed with the lithium niobate thin film layer, wherein the lithium niobate thin film layer and the second isolation layer are bonded with each other, then a substrate of the second bonded wafer is thinned, and then a metal layer and an upper cladding layer are prepared on a side of the lithium niobate thin film layer facing away from the silicon nitride waveguide layer.
